(19) United States
(12) Patent Application Publication
(10) Pub. No.: US 2009/0205509 A1
(43) Pub. Date: Aug. 20, 2009

(54) Device for Preserving, Cooking and Automatically Dispensing Dough Based Products, Such as Bread

(76) Inventors: Erick Canicas, Bouliac (FR); Didier Chateau, Blanquefort (FR)

Correspondence Address: YOUNG & THOMPSON, 209 Madison Street, Suite 500, ALEXANDRIA, VA, 22314, US

(21) Appl. No.: 11/816,347

(22) PCT Filed: Feb. 17, 2006
(86) PCT No.: PCT/FR2006/000366

§ 371 Date: Aug. 15, 2007

(30) Foreign Application Priority Data
Feb. 17, 2005 (FR) 0550454
Dec. 22, 2005 (FR) 0554031

(51) Int. Cl. A21B 1/06; A21B 1/42; F24C 7/04

(52) U.S. Cl. 99/357; 99/443 C; 219/388; 219/400; 219/553

(57) ABSTRACT

The invention relates to a device for preserving, cooking and automatically dispensing dough-based products, such as bread. The inventive device is characterised in that it comprises an area (12) for storing frozen products and an area (16) for cooking same with at least one source of short waves having a wavelength of less than 2 ?m for quick cooking.

This invention relates to a device for preserving, baking and automatic dispensing of dough-based products, especially bakery products, more particularly adapted to dough rolls.

The bakery sector has greatly evolved due to changes in the behavior of consumers, the latter seeking fresh and crusty bread anytime and anywhere.

To meet these expectations, the so-called artisanal bakery offers a quality bread, made by a trained professional. Sometimes, sales hours are restricted with consideration of salary costs for selling and regulations associated with work hours.

Moreover, the work of a baker is relatively arduous and does not encourage vocations so that traditional bakeries are tending to disappear.

Finally, in the future, artisanal bakeries will have to confront fierce competition from chains of baking terminals that offer fresh and crusty bread at various hours of the day.

To improve production flexibility, industrial bakeries offer precooked or frozen dough rolls that are made in a factory to then be delivered to points of sale where they are baked after having possibly undergone a stage of rising for the frozen dough rolls.

This mode of production has many advantages.

First of all, the terminal phase of baking requires much less investment than a traditional bakery.

Moreover, it is possible to furnish different batches on the same day so that hot and crusty bread can be offered at various times during the day.

Finally, the individual who completes preparation of the bread at the point of sale does not need to be trained, the remaining stages not requiring the skill of a baker.

With regard to quality, if the rising and baking parameters are observed at the level of the baking terminal, these operating modes make it possible theoretically to obtain bread of satisfactory quality.

Even if an industrial bakery improves flexibility, it does not solve all problems.

Actually, even if the installation of a point of sale equipped with a baking terminal requires an investment less than that of a traditional bakery, this installation nevertheless requires premises, a non-negligible investment, so that it is not possible to increase the number of points of sale.

Moreover, this point of sale always requires at least one employee so that the restrictions associated especially with regulation of working hours dictate open hours that cannot be extended. Consequently, the consumer is not able to buy bread at certain times of the day, especially the evening.

Finally, the quality of the bread is in fact mediocre because the individuals responsible for baking do not scrupulously observe the rising and baking parameters for various reasons.

In addition, this invention is designed to eliminate the disadvantages of the prior art by suggesting a device for preserving, baking and automatic dispensing of dough-based products, especially bakery products allowing availability of a hot and crusty quality product at any time.

To do this, the object of the invention is a device for preserving, baking and automatic dispensing of dough-based products, especially loaves of bread, characterized in that it comprises a zone for storage of frozen products, a baking zone with at least one source of short infrared waves with a wavelength of less than 2 μm, so as to attain rapid baking.

Other characteristics and advantages will become apparent from the following description of the invention given only by way of example, with respect to the attached drawings, in which:

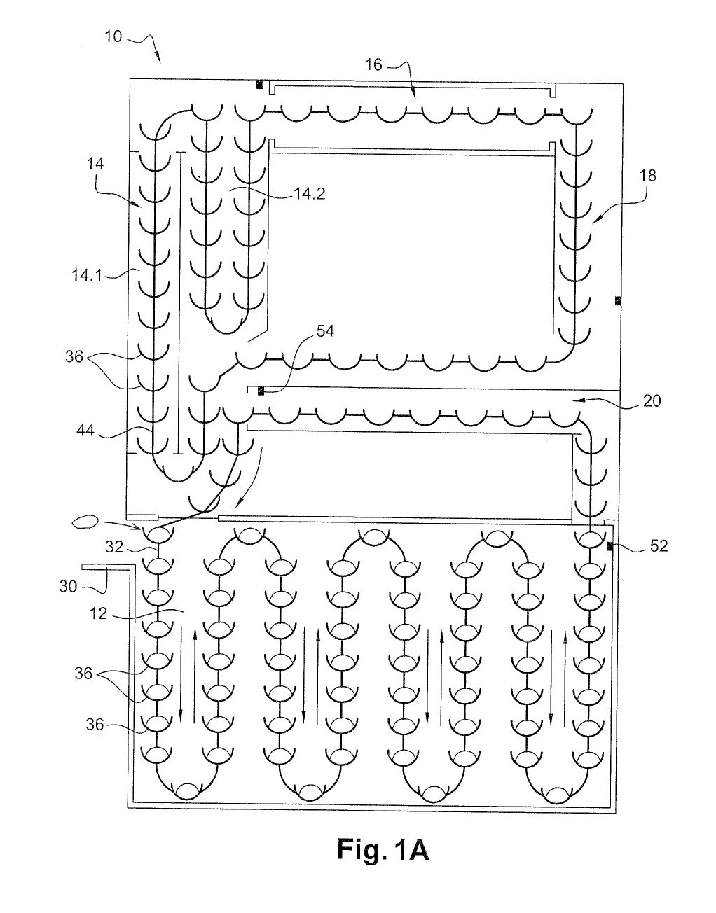

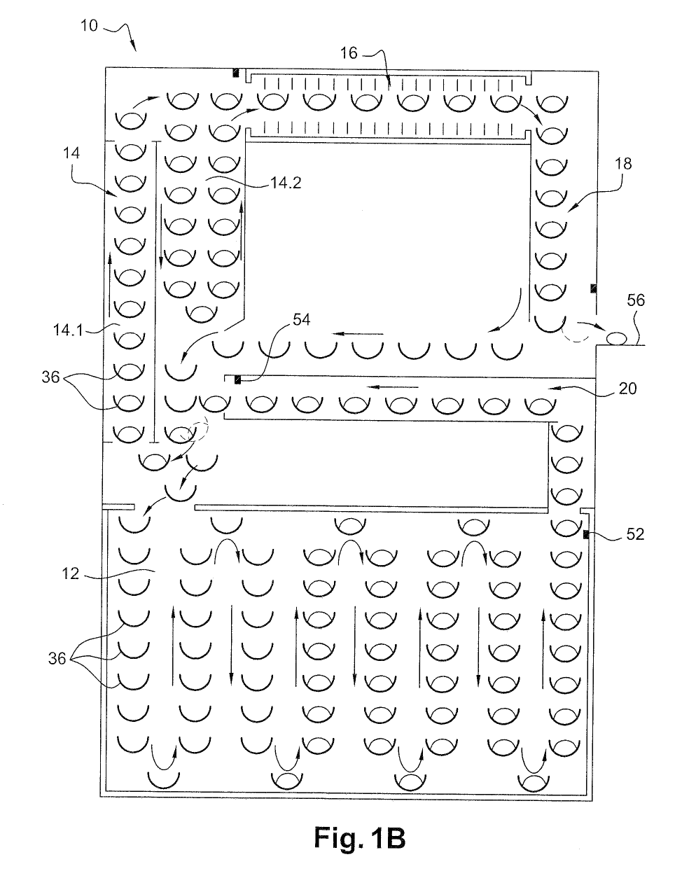

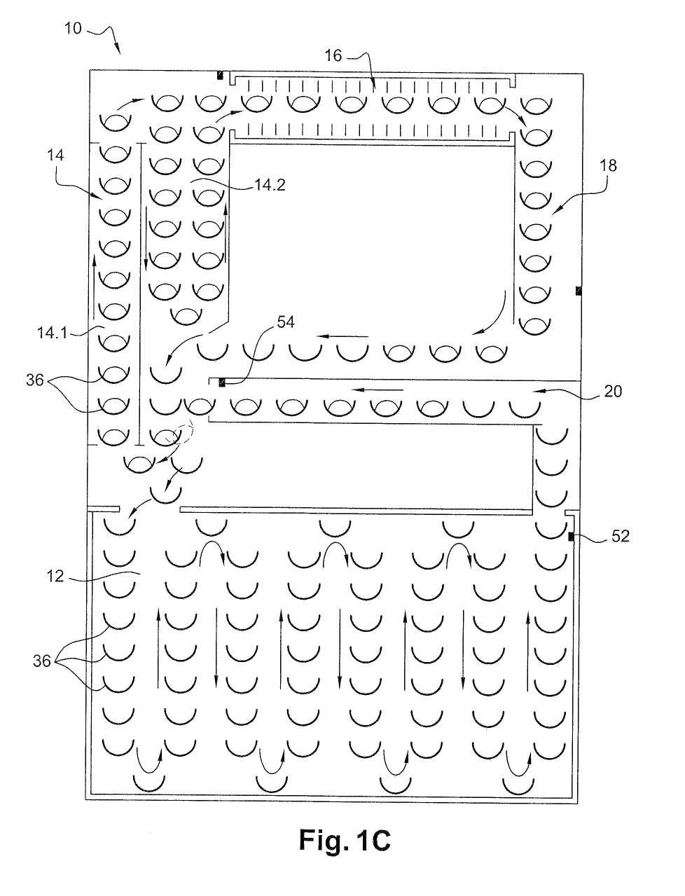

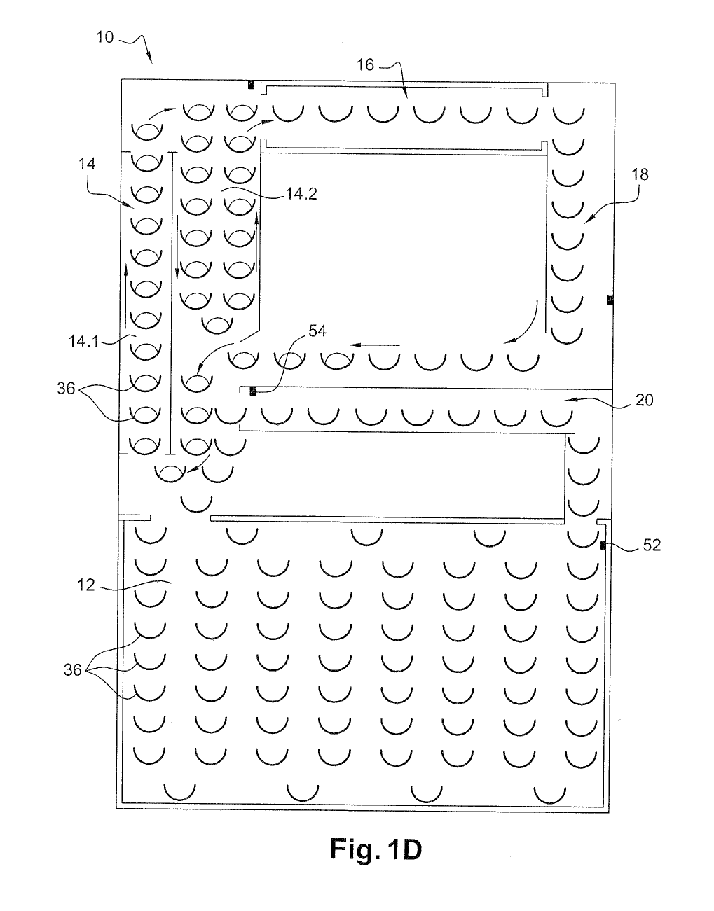

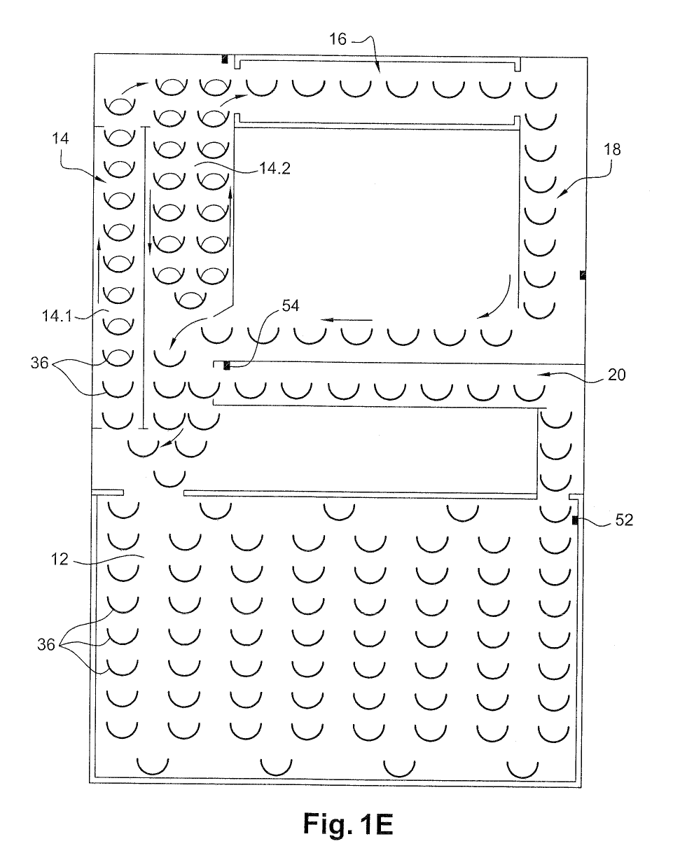

FIG. 1A is a schematic of the preservation and baking device during loading,

FIG. 1B is a schematic of the preservation and baking device during production with dispensing of a loaf of bread,

FIG. 1C is a schematic of the preservation and baking device during production without dispensing of bread,

FIG. 1D is a schematic of the preservation and baking device at the end of baking,

FIG. 1E is a schematic of the reinitialized preservation and baking device, prepared for dispensing of a loaf of bread,

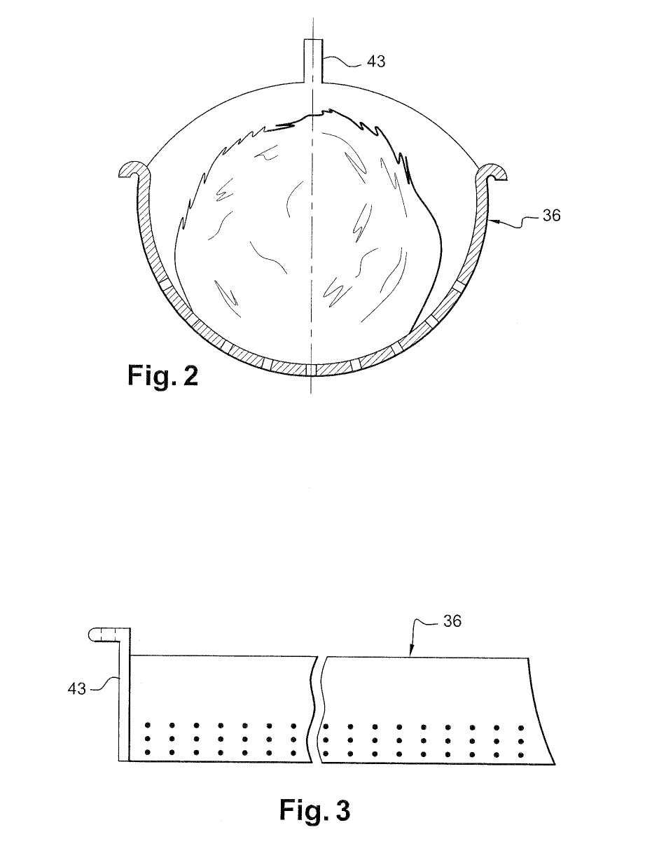

FIG. 2 is a front view of a dough roll in a cavity,

FIG. 3 is a side view of a cavity,

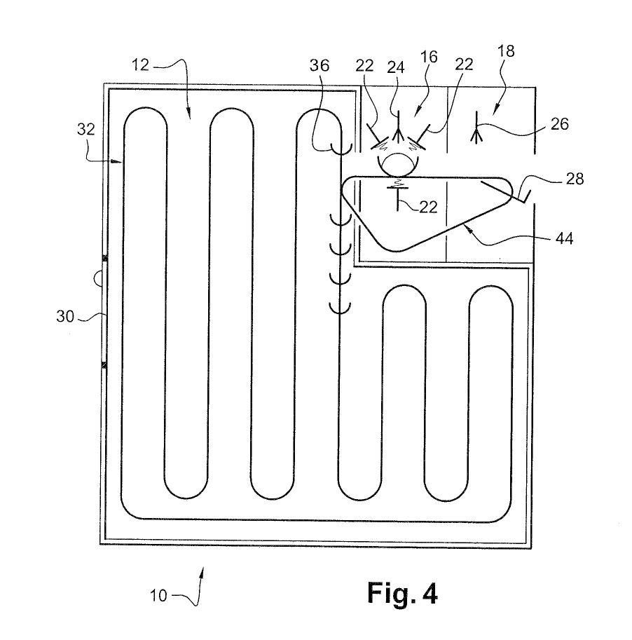

FIG. 4 is a section that schematically shows a device according to the invention,

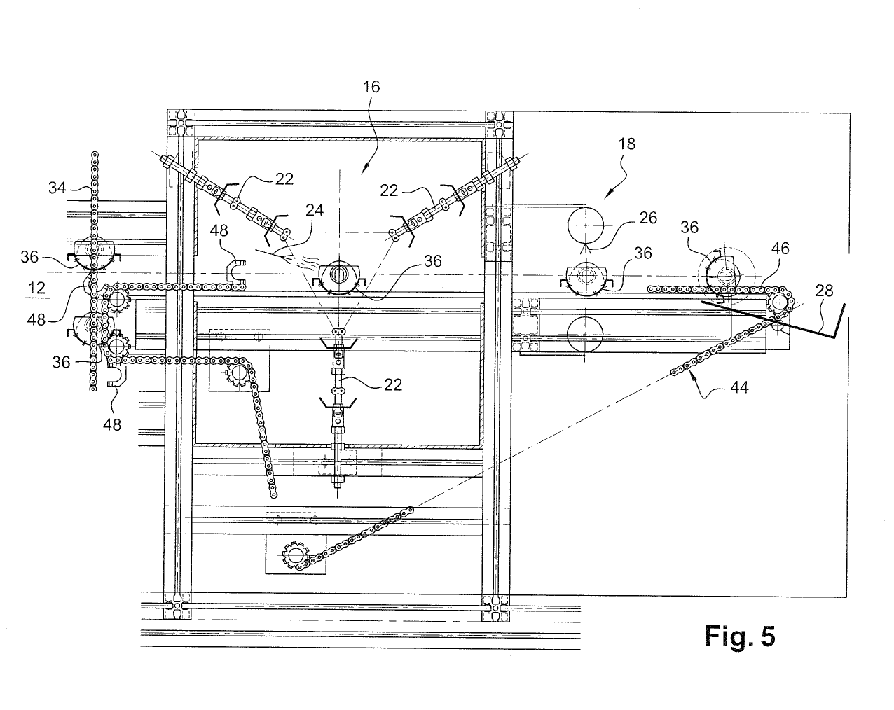

FIG. 5 is a section that shows in detail the baking and cooling means,

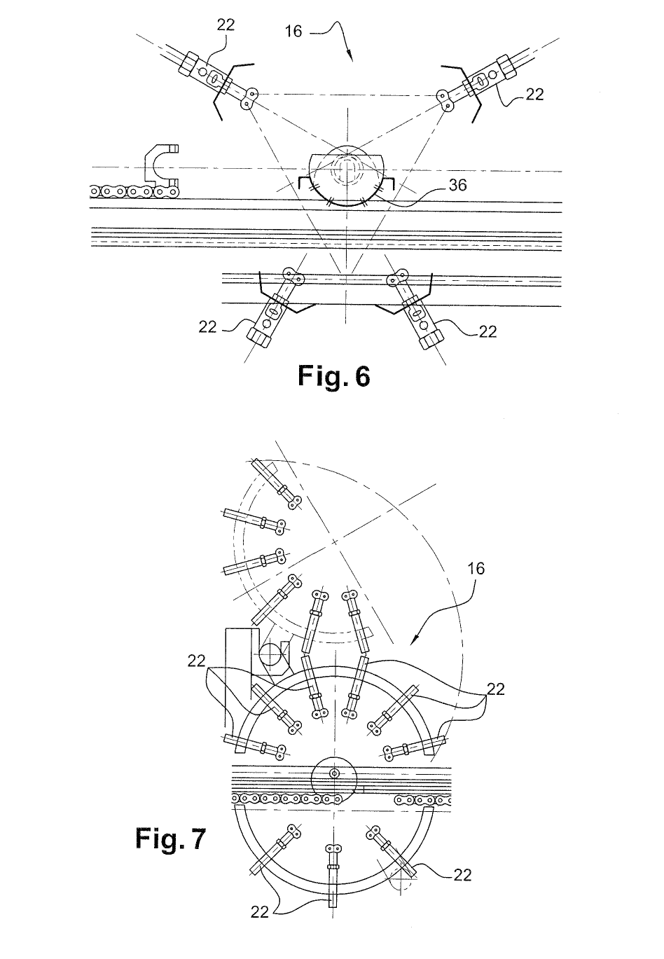

FIG. 6 is a section that shows in detail another variant of the baking zone,

FIG. 7 is a section that shows in detail another variant of the baking zone,

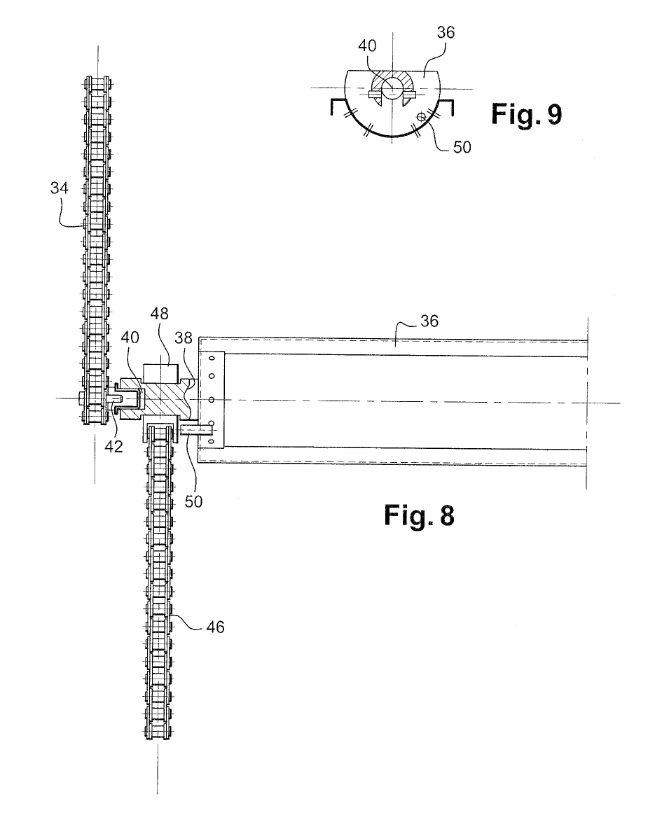

FIG. 8 is a top half-view showing a support, and

FIG. 9 is a transverse section of a support.

In the figures, a device for preserving and baking dough-based products, especially bakery products, more particularly adapted to bread, is labeled 10.

Even if the invention is described as applied to the baking of dough rolls for purposes of making bread, it can be used for all bakery products, i.e., all varieties of breads or pastries. Likewise, it could be used to bake pizzas or any other dough-based product.

According to the invention, the device comprises a zone 12 for storing frozen dough rolls, if necessary a zone 14 for raising or holding the dough rolls (not shown), a baking zone 16 and preferably a cooling zone 18 for the baked bread. At the outlet level, the device can comprise a zone for packaging of the bread under a controlled atmosphere.

The storage zone 12 is designed to keep the frozen dough rolls at a sub-zero temperature, for example roughly −10 to −20° C. in order to immobilize the dough so that it does not rise.

The dough rolls can remain in this zone 12 without any change in their structure.

According to one variant, at the outlet of the frozen storage zone 12, the dough roll can cross the holding zone 14 that is designed to keep the dough roll at the rising temperature, for example roughly 18° C. During this phase of rising, dough-proofing proceeds uniformly in all the dimensions of the dough roll. Advantageously, to improve rising, the dough roll is subjected to prior above-zero cold in the holding zone, for example roughly +2 to +4° C. to thaw the dough thoroughly without the start of dough-proofing. To do this, a thawing zone 20 can be provided between the frozen storage zone and the holding zone.

Preferably, the holding zone 14 comprises two parts 14.1 and 14.2 to improve rising. Thus, in the first part 14. 1, the dough roll is subjected to a first holding temperature, for example of roughly 17° C., whereas in the second part 14.2, the dough roll is subjected to a second holding temperature that is higher than the first, for example roughly 25° C.

To allow good dough-proofing, each loaf must remain in the holding zone 14 for a predetermined interval of roughly 4 ½ hours.

At the outlet of the holding zone, the dough rolls enter the baking zone 16.

According to one preferred embodiment, the dough roll is transferred directly to the baking zone 16 upon leaving the storage zone.

According to one embodiment, at least one source of short infrared waves is used to obtain rapid baking. This type of baking bakes only the dough roll; this makes it possible to avoid making a baking module that is insulated and heated permanently.

According to the invention, the source emits short infrared waves of less than 2 μm in wavelength, and preferably from 1 to 1.4 μm in wavelength.

This type of radiation makes it possible to raise the temperature very quickly and to move from 0 to 800° C. in a few seconds.

To obtain rapid baking, roughly 45 seconds to 1 minute, the sources should be moved to a distance of roughly 10 to 16 cm from the item to be baked, ensuring that the sources do not emit in the direction of the item to be baked, but with a slight offset angle of a few degrees.

At the outlet of the baking zone, the dough roll is transformed into hot, crusty bread.

Preferably, the baking zone 16 comprises three wave sources 22 located at 120° to be able to irradiate the dough roll or rolls that can be essentially stopped in the middle of the three sources 22, as shown in FIG. 5.

According to another variant shown in FIG. 6, the baking zone 16 can comprise four sources 22, two located above the item to be baked and two others underneath. The sources are separated from the item to be baked at a distance of roughly 10 to 16 cm, preferably roughly 13 cm, the sources from above being moved away roughly 20 to 25 cm, and being moved apart from one another by a greater distance than those from underneath. In this case, the sources have a power of roughly 3000 W each.

According to another variant shown in FIG. 7, the baking zone 16 comprises a plurality of sources 22 inserted on semi-cylindrical supports, one placed above the item to be baked and the other underneath. According to one variant, the top support can pivot so as to clear the item to be baked, as shown in dotted lines in FIG. 7. According to one example, the top support comprises six sources and the bottom support comprises three sources, and they have a radius of curvature of roughly 14 cm. According to this embodiment, each source has a power of roughly 1100 W.

According to one embodiment, each source has the form of an elongated lamp extending essentially parallel to the item to be baked. According to the variants, the lamp comprises two filaments with a metal reflector.

Advantageously, the baking zone 16 comprises means 24 for generating an air flow at the level of the dough roll at least during baking to obtain thorough baking and a crust that is not overly hard. Preferably, the air flow is formed at one end of the item to be baked and flows essentially parallel to the item to be baked.

Subsequently, the loaves of bread enter the cooling zone 18. There are cooling means 26, especially at least one air flow, in the cooling zone 18. Advantageously, the energy recovered from the freezing operation can be used to obtain a temperature of roughly twenty degrees.

When the bread is brought to a temperature of roughly 20 degrees, it is moved toward a dispensing zone that is accessible to the customer via an opening that may be blocked by a movable flap. According to one embodiment, the baked product is dropped on an inclined plane 28 with a stop in the lower part.

The device according to the invention comes in the form of a cabinet. The walls of the storage zone 12 are suitably insulated to limit thermal leakage.

There is a door 30 to allow the dough rolls to be fed into the storage zone.

The device according to the invention comprises in the upper part a baking zone 16, and possibly a cooling zone 18. The device of the invention comes in the form of an automatic dispenser and includes a coin slot (not shown) that controls baking.

According to another characteristic of the invention, the device comprises at least two conveyors to ensure the transfer of the products from the storage zone to the dispensing zone.

Thus, the storage zone 12 comprises a first conveyor 32 in the form of a bucket-conveyor, with two parallel chains 34 located along the path of the products, between which there are supports 36 for the products. The supports 36 come in the form of at least one wave or semi-cylinder, as shown in FIGS. 2 and 9. Each support 36 comprises on each of its ends a seat 38 with a housing 40 at the level of the free end with a side opening allowing a finger 42 connected to one of the chains 34 to be inserted.

According to one embodiment, each support is made of aluminum alloy that is preferably loaded with magnesium to increase stiffness. These supports have a thickness of roughly 1 mm, a length of roughly 800 mm, and a depth of roughly 30 mm.

They preferably comprise a curved side edge to increase the stiffness.

In one variant, as shown in FIGS. 2 and 3, the support 36 can be connected to only one end 43 using suitable means such as a hook, for example.

The device likewise comprises a second conveyor 44 that can ensure the transfer of at least one support from the first conveyor 32 to the dispensing zone, whereby said at least one support 36, transferred by the second conveyor 44, is able to spend a stopping time at the level of the baking zone 16.

According to one embodiment shown in FIGS. 5 and 8, the second conveyor comprises two parallel looped chains 46 that can be located on either side of the supports. Each chain 46 comprises hooks 48 that are located facing one another so as to grip the supports, the dimensions of the hooks 48 being adapted to those of the seats 38.

The arrangement of the hooks is adapted to grip one or more supports that can be located more or less at a distance to one another at the level of the second conveyor 44.

According to another characteristic of the invention, the device comprises means that cause tipping of the supports 36 at the level of the dispensing zone. According to one embodiment, the device comprises a fixed stop at the level of the dispensing zone against which a finger 50 can be supported; the finger is located at the level of at least one end of the support, offset relative to the seat 38. Thus, when the support moves in translation, driven by the second conveyor, and arrives at the level of the dispensing zone, the finger 50 comes into contact against the fixed stop. From this instant, translation of the support drives its tipping, the finger 50 being immobilized against the fixed stop. During tipping of the support, the baked product falls onto the inclined plane of the dispensing zone.

To allow passage from one zone to another, passage openings are arranged at the level of the partitioning walls, said openings comprising deformable flexible doors or walls to allow passage of the supports, while limiting the heat leakage especially at the level of the storage zone 12.

The device of the invention likewise comprises control means that make it possible to control the temperatures in different zones and especially the emission of radiation in the baking zone as well as to control the progress of the conveyors.

The operating mode of the device is now described with respect to FIGS. 4 and 5.

In the first phase, an operator loads the dough rolls into the device, arranging them on the supports 36 by placing the bottom of the dough roll against the wall of the support. During this phase, the first conveyor 32 advances step by step while the second conveyor 44 is stopped. Preferably, loading is done until all the supports comprise at least one dough roll.

At rest, the first conveyor 32 is preferably immobilized so that a product to be baked is present on the support located at the level of the second conveyor 44.

When a customer orders a product, the second conveyor 44 starts to move. As it advances, the hooks 48 grip at least one support 36 and move it as far as the baking zone 16. When a product is located in the baking zone 16, the second conveyor stops advancing.

The wave sources 22 are activated at least at the time at which the product is stopped in the baking zone 16. The product irradiated by the waves is baked in 30 seconds. An air flow is projected onto the product during at least part of its baking.

After baking, the second conveyor 44 is restarted. Depending on the case, the support can spend a stopping time or not at the level of the cooling zone 18. The cooling means 26 are preferably activated promptly when the product is present to the right of the cooling means. After cooling, the second conveyor 44 moves the support into the dispensing zone, at the level of which it tips, causing the baked product to fall onto an inclined plane accessible to the customer.

In addition, the device can comprise a bag dispenser.

The device according to the invention has the following advantages:

Siting and investment being relatively reduced, the number of dispensing sites can be increased in the manner of other automatic dispensers.

Moreover, since the system is completely automated, the quality of the bread is constant and does not depend on an individual.

Finally, the bread can be dispensed anytime without any restriction tied to working hours.

According to another variant, the dough roll can be baked, not statically as described above, the dough roll spending a stopping time during baking, but continuously. In this case, the dough roll advances continuously under the wave sources 22, the rate of advance being adapted as a function of the desired baking. In this case, the wave sources are present in the form of elongated lamps arranged along the direction of advance of the loaf of bread.

Another operating mode of the device is described with respect to FIGS. 1A to 1E.

In a first phase, an operator loads the device with dough rolls, arranging them in each of the cavities 36 with the bottom of the dough roll placed against the wall of the cavity, as shown in FIG. 1A. During this phase, the first conveyor 32 advances step by step while the second conveyor 44 can be stopped. Preferably, loading is done until a sensor 52 located at the level of the outlet of the freezing storage zone 12 detects the presence of a dough roll in the cavity located just in front of the outlet from said zone.

According to another variant, loading is done until a sensor 54 located at the level of the outlet of the thawing zone 20 detects a dough roll in the cavity located just in front of the outlet from said zone.

During the bread production phase, shown in FIGS. 1B and 1C, the two conveyors advance step by step in a synchronized manner. The advance of the conveyors is adjusted such that each dough roll remains in the holding zone for a suitable interval.

During the production stage, the dough rolls are transferred from the first conveyor to the second conveyor by pivoting of the cavity of the first conveyor located to the right of the tipping means. During transfer, the orientation of the dough roll is modified. Thus, the dough rolls rest on the bottom at the level of the cavities of the second conveyor.

During this phase, the dough rolls cross the holding zone 14 and remain in this zone for a suitable interval to obtain the required rising. Then, the dough rolls cross the baking zone 16 where they are baked. Finally, the loaves of bread are cooled in the zone 18 and packaged if necessary. Depending on the case, if a coin is inserted into the coin slot, a loaf of bread is discharged at the level of an outlet door 56, as shown in FIG. 1B. In another variant, if no coin is inserted, the wrapped bread remains in the cavity and follows the path formed by the loop of the second conveyor, as shown in FIG. 1C.

The first conveyor can stop advancing when all of the cavities of said conveyor are empty.

As shown in FIG. 1D, when the wrapped loaves of bread remain on the second conveyor, operation of the baking zone 16 is stopped so that when the first cavity loaded with wrapped bread enters said zone, the temperature is not too high. Preferably, operation of the baking zone is stopped when the last loaf of bread is baked.

Finally, when no customers have inserted a coin, the second conveyor advances until the first loaf of bread is located to the right of the outlet, as shown in FIG. 1E. After baking the last loaf of bread, the advance of the second conveyor can be accelerated to reinitialize the device.

As a variant, the loaves of bread can enter the packaging zone at the level of the outlet. When the loaf of bread is brought to a temperature of some twenty degrees, it is placed in a preferably sealed bag.

This bag is opened using a blower with a mouth in the form of a funnel in order to facilitate insertion of the bread into the bag.

Advantageously, a neutral gas or a modified atmosphere is injected to modify the components of the gas trapped in the bag with the bread. Preferably, a nitrogen-rich gas is used.

Packaging under a neutral or modified atmosphere makes it possible to keep the bread fresh and crusty for several hours or several days after baking.

Of course, the invention is obviously not limited to the embodiment that is shown and described above; conversely, however, it covers all variants, especially with respect to the nature and forms of the various elements. In certain cases, the device need not comprise a holding zone, especially when prebaked dough rolls are used.

Finally, although described as applied to bread, the device of the invention can be used by adapting the supports for the dispensing of other dough-based products such as pizzas, for example.

1. Device for preserving, baking and automatic dispensing of dough-based products, especially bread, characterized in that it comprises a zone (12) for storage of frozen products, a baking zone (16) with at least one short-wave source emitting short infrared waves with a wavelength of less than 2 μm, so as to attain rapid baking.

2. Device for preserving, baking and automatic dispensing of dough-based products, especially bread, according to claim 1, wherein the baking zone (16) comprises sources emitting short infrared waves roughly less than 1 μm to 1.4 μm in wavelength.

3. Device for preserving, baking and automatic dispensing of dough-based products, especially bread, according to claim 1, wherein the baking zone (16) comprises means (24) for generating an air flow at the level of the dough roll at least during baking.

4. Device for preserving, baking and automatic dispensing of dough-based products, especially bread, according to claim 1, wherein it comprises a cooling zone (18) following the baking zone (16).

5. Device for preserving, baking and automatic dispensing of dough-based products, especially bread, according to claim 1, wherein it comprises at least two conveyors to ensure the transfer of the products from the storage zone to the dispensing zone.

6. Device for preserving, baking and automatic dispensing of dough-based products, especially bread, according to claim 5, wherein the storage zone (12) comprises a first conveyor (32) with two parallel chains (34), located along the path of the products, between which there are supports (36) for the products, each support (36) comprising on each of its ends a seat (38) with a housing (40) at the level of the free end with a side opening that allows a finger (42) connected to one of the chains (34) to be inserted.

7. Device for preserving, baking and automatic dispensing of dough-based products, especially bread, according to claim 5, wherein it likewise comprises a second conveyor (44) that can ensure the transfer of at least one support from the first conveyor (32) to the dispensing zone, said at least one support (36), transferred by the second conveyor (44), being able to spend a stopping time at the level of the baking zone (16).

8. Device for preserving, baking and automatic dispensing of dough-based products, especially bread, according to claim 7, wherein the second conveyor comprises two parallel looped chains (46) that can be located on either side of the supports, each chain (46) comprising hooks (48) located facing one another so as to grip the supports.

9. Device for preserving, baking and automatic dispensing of dough-based products, especially bread, according to claim 7, wherein it comprises means for causing tipping of the supports (36) at the level of the dispensing zone with a fixed stop at the level of the dispensing zone against which a finger (50) that is provided at the level of at least one end of each support can be supported.

10. Device for preserving, baking and automatic dispensing of dough-based products, especially bread, according to claim 2, wherein the baking zone (16) comprises means (24) for generating an air flow at the level of the dough roll at least during baking.

11. Device for preserving, baking and automatic dispensing of dough-based products, especially bread, according to claim 2, wherein it comprises a cooling zone (18) following the baking zone (16).

12. Device for preserving, baking and automatic dispensing of dough-based products, especially bread, according to claim 2, wherein it comprises at least two conveyors to ensure the transfer of the products from the storage zone to the dispensing zone.

13. Device for preserving, baking and automatic dispensing of dough-based products, especially bread, according to claim 6, wherein it likewise comprises a second conveyor (44) that can ensure the transfer of at least one support from the first conveyor (32) to the dispensing zone, said at least one support (36), transferred by the second conveyor (44), being able to spend a stopping time at the level of the baking zone (16).

14. Device for preserving, baking and automatic dispensing of dough-based products, especially bread, according to claim 8, wherein it comprises means for causing tipping of the supports (36) at the level of the dispensing zone with a fixed stop at the level of the dispensing zone against which a finger (50) that is provided at the level of at least one end of each support can be supported.
